(19) United States
(12) Patent Application Publication
(10) Pub. No.: US 2018/0172085 A1
(43) Pub. Date: Jun. 21, 2018

(54) SYSTEM AND METHOD FOR CLUTCH ACTUATION HAVING ELECTRONIC CLUTCH ACTUATOR WITH MANUAL OPERATION

(71) Applicant: BorgWarner Inc., Auburn Hills, MI (US)

(72) Inventors: Michael Campbell, Royal Oak, MI (US); Calahan Campton, Royal Oak, MI (US); Xinqian Xiang, Troy, MI (US)

(21) Appl. No.: 15/843,286

(22) Filed: Dec. 15, 2017

Related U.S. Application Data
(60) Provisional application No. 62/434,825, filed on Dec. 15, 2016.

(51) Int. Cl. F16D 25/12; F16D 28/00; B60K 23/02; F16H 37/04; F16D 48/06; F15B 1/02; F15B 1/033; F15B 13/02

(52) U.S. Cl. CPC F16D 25/12; F16D 28/00; B60K 23/02; F16H 37/04; F16H 1/06; F15B 1/022; F15B 1/033; F15B 13/021; F16D 48/06

(57) ABSTRACT

A system and method for actuation of a clutch in a transmission of a vehicle including an electronic clutch actuator adapted to be in fluid communication with a clutch slave cylinder coupled to the clutch of the transmission and a manual override assembly adapted to be in fluid communication between a clutch footpedal of the vehicle and the clutch slave cylinder, wherein the manual override assembly prevents fluid flow from the clutch footpedal to the clutch slave cylinder when the electronic clutch actuator is being used to electronically actuate the clutch slave cylinder and allows fluid flow from the clutch footpedal to the clutch slave cylinder when the electronic clutch actuator is not being used to manually actuate the clutch slave cylinder.

### CROSS-REFERENCE TO RELATED APPLICATION(S)

The present application claims priority to and all the benefits of U.S. Provisional Patent Application No. 62/434,825, filed on Dec. 15, 2016, which is hereby expressly incorporated herein by reference in its entirety.

### BACKGROUND OF INVENTION

### 1. Field of Invention

The present invention relates generally to clutches for transmissions and, more specifically, to a system and method for actuation of a clutch in a transmission having an electronic clutch actuator with manual operation.

### 2. Description of the Related Art

Conventional vehicles typically include an engine having a rotational output that provides a rotational input into a transmission such as a manual transmission for a powertrain system of the vehicle. The transmission changes a rotational speed and torque generated by the output of the engine through a series of predetermined gearsets in a gearbox to transmit power to one or more wheels of the vehicle, whereby changing between the gearsets enables the vehicle to travel at different vehicle speeds for a given engine speed.

When a vehicle operator or driver wants to change from one gear to another, the driver presses down on a clutch footpedal of the vehicle. This operates a single clutch via a linkage, which disconnects the output of the engine from the input into the gearbox and interrupts power flow to the transmission. Then the vehicle operator uses a shift lever to select a new gear, a process that typically involves moving a toothed collar from one gear to another gear of a different size. In the gearbox, synchronizers match the gears before they are engaged to prevent grinding. Once the new gear is engaged, the driver releases the clutch footpedal, which re-connects the output of the engine to the input of the gearbox to transmit power to the wheels.

For the above-described transmission, original equipment manufacturers are developing enhanced clutch systems for manual transmissions to continually reduce carbon dioxide output and meet fuel saving requirements, which can provide new cost effective functionalities like automated free rolling operation (sailing) when the driver does not require engine torque. For example, an enhanced clutch system includes an electronic clutch actuator driven from vehicle controls to engage and disengage the clutch. However, the enhanced clutch system must function conventionally, and control the clutch independently of the vehicle driver's actions as well for shifting gears in transmissions. Thus, there is a need in the art to provide a system and method for actuation of a clutch in a transmission having an electronic clutch actuator with manual operation.

### SUMMARY OF THE INVENTION

The present invention provides a system for actuation of a clutch in a transmission of a vehicle including an electronic clutch actuator adapted to be in fluid communication with a clutch slave cylinder coupled to the clutch of the transmission and a manual override assembly adapted to be in fluid communication between a clutch footpedal of the vehicle and the clutch slave cylinder, wherein the manual override assembly prevents fluid flow from the clutch footpedal to the clutch slave cylinder when the electronic clutch actuator is being used to electronically actuate the clutch slave cylinder and allows fluid flow from the clutch footpedal to the clutch slave cylinder when the electronic clutch actuator is not being used to manually actuate the clutch slave cylinder.

In addition, the present invention provides a method for actuation of a clutch in a transmission of a vehicle including the steps of providing an electronic clutch actuator in fluid communication with a clutch slave cylinder coupled to the clutch of the transmission, providing a manual override assembly in fluid communication between a clutch footpedal of the vehicle and the clutch slave cylinder, preventing, by the manual override assembly, fluid flow from the clutch footpedal to the clutch slave cylinder when the electronic clutch actuator is being used to electronically actuate the clutch slave cylinder, and allowing, by the manual override assembly, fluid flow from the clutch footpedal to the clutch slave cylinder when the electronic clutch actuator is not being used to manually actuate the clutch slave cylinder.

One advantage of the present invention is that a system and method is provided for actuation of a clutch in a transmission having an electronic clutch actuator with manual operation. Another advantage of the present invention is that the system and method allows both a vehicle driver and the system to control the clutch seamlessly for shifting gears in the transmission. Yet another advantage of the present invention is that the system and method utilizes an electronic clutch actuator driven from vehicle controls. Still another advantage of the present invention is that the system and method implements a separate component adapted to manual transmissions. A further advantage of the present invention is that the system and method is an “add-on” to the clutch system without any change in a vehicle driver's actions.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a diagrammatic view of one embodiment of a system, according to the present invention, for actuation of a clutch in a transmission with an electronic clutch actuator.

FIG. 2 is a diagrammatic view of the system of FIG. 1 illustrating the clutch engaged.

FIG. 3 is a diagrammatic view of the system of FIG. 1 illustrating the clutch disengaged.

FIG. 4 is a diagrammatic view of the system of FIG. 1 illustrating a clutch by wire connection.

FIG. 5 is a diagrammatic view of the system of FIG. 1 illustrating a clutch by fluid connection

FIG. 6 is a diagrammatic view of the system of FIG. 5 with the electronic clutch actuator being used.

FIG. 7 is a diagrammatic view of the system of FIG. 5 with the electronic clutch actuator not being used.

### DETAILED DESCRIPTION OF THE INVENTION

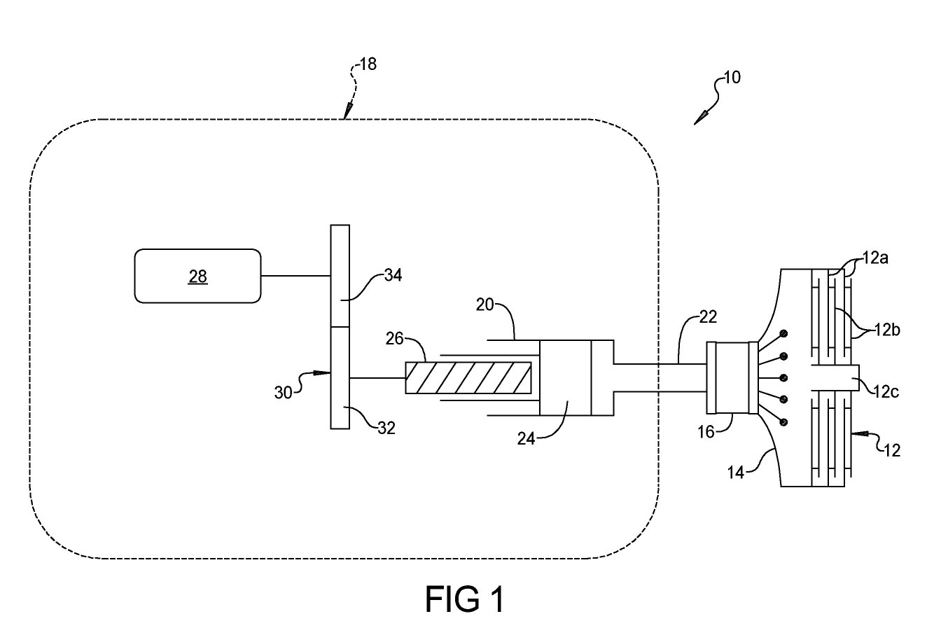

Referring now to the figures, where like numerals are used to designate like structure unless otherwise indicated, a system 10, according to the present invention, for actuation of a clutch, generally indicated at 12, in FIG. 1 for a transmission (not shown) of a vehicle (not shown). The vehicle includes an engine (not shown) and the transmission. In one embodiment, the engine is a conventional internal combustion engine known in the art. In one embodiment, the transmission is a manual transmission (MT). The engine has a rotatable output that is an engine input into the transmission. The transmission translates the engine input to a rotational output to transmit power to one or more wheels (not shown) of the vehicle. It should be appreciated that the clutch 12 is typically disposed between the engine input and an input shaft of a gearbox (not shown) of the transmission. It should also be appreciated that the system 10 forms an enhanced clutch system for the transmission. It should further be appreciated that the engine and/or transmission could be of any suitable type to drive the vehicle, without departing from the scope of the present invention.

As illustrated in FIG. 1, the clutch 12 is of a clutch pack type. In one embodiment, the clutch 12 includes a plurality of clutch plates 12a and a plurality of clutch disc 12b interleaved between and cooperating with the clutch plates 12a. The clutch discs 12b are coupled to a rotatable input shaft 12c of the gearbox. The clutch 12 includes a diaphragm spring 14 coupled to the clutch plates 12a to engage and disengage the clutch plates 12a with the clutch discs 12b. The clutch 12 also includes a clutch slave cylinder 16 coupled to the diaphragm spring 14 to actuate the diaphragm spring 14 to cause engagement and disengagement of the clutch plates 12a with the clutch discs 12b. It should be appreciated that the clutch slave cylinder 16 is a fluid cylinder having a movable piston coupled to the diaphragm spring 14. It should also be appreciated that the clutch 12 is conventional and known in the art.

The system 10 also includes an electronic clutch actuator, generally indicated at 18, for actuating the clutch 12. In one embodiment, the electronic clutch actuator 18 includes a clutch master cylinder 20 fluidly connected by a conduit 22 to the clutch slave cylinder 16. The electronic clutch actuator 18 also includes a movable piston 24 disposed in the clutch master cylinder 20. It should be appreciated that movement of the piston 24 causes movement of fluid to actuate the clutch slave cylinder 16.

The electronic clutch actuator 18 includes a rotatable screw 26 coupled to the piston 24 to move or translate the piston 24. The rotatable screw 26 may cooperate with the piston 24 such that, when the rotatable screw 26 is rotated, this rotational movement causes translational movement of the piston 24. The electronic clutch actuator 18 includes a motor 28 for rotating the rotatable screw 26. The motor 28 is of a brushless direct current (BLDC) reversible or two directional output type and connected to a source of power. The electronic clutch actuator 18 further includes a geartrain, generally indicated at 30, between the motor 28 and the rotatable screw 26. In one embodiment, the geartrain 30 includes a first gear 32 coupled to the rotatable screw 26 and a second gear 34 coupled to the motor 28 for a predetermined gear ratio. It should be appreciated that the first gear 32 and second gear 34 meshingly engage each other to reduce the rotational output of the motor 28 to the rotatable screw 26.

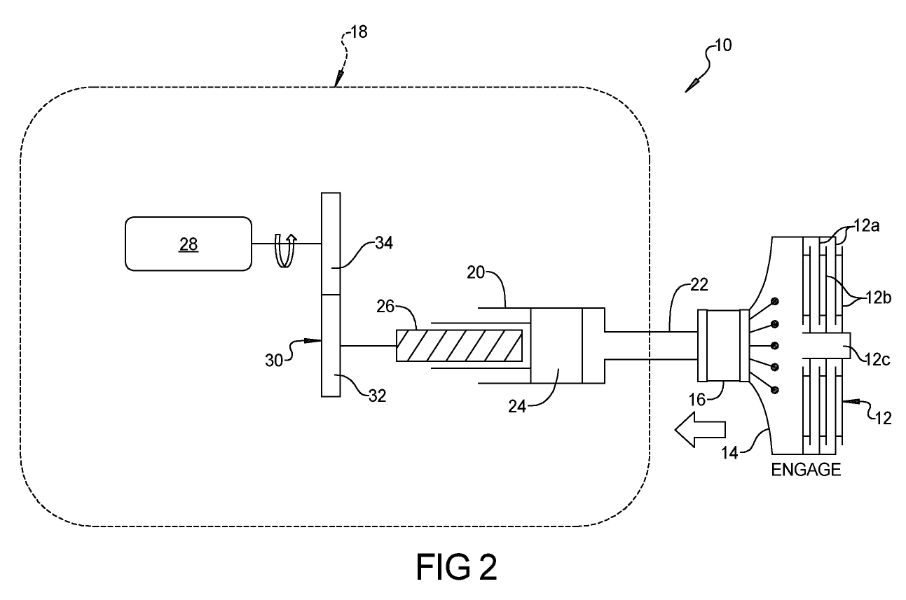

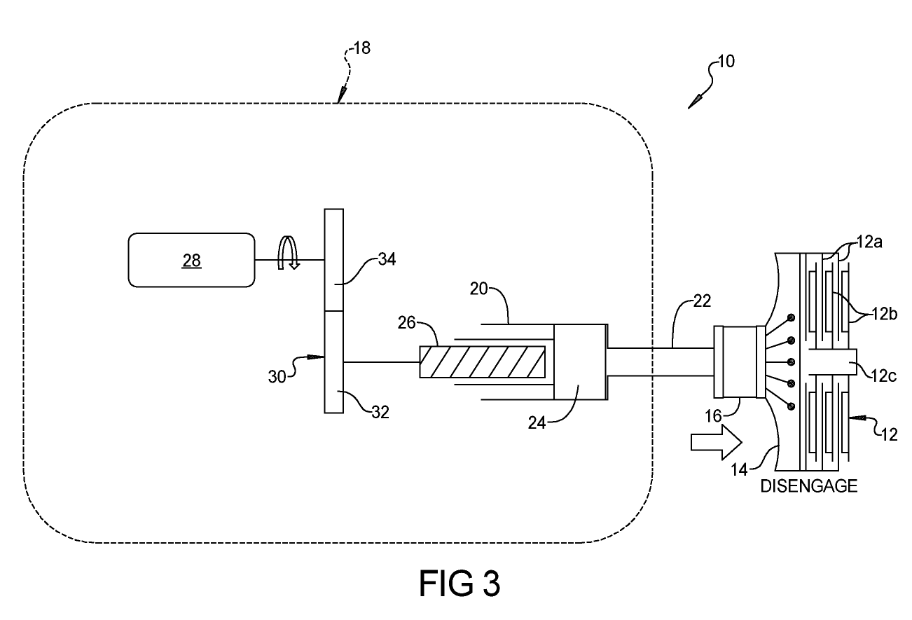

Referring to FIGS. 2 and 3, the system 10 is illustrated with the clutch 12 in an engaged position and disengaged position, respectively. As illustrated in FIG. 2, the motor 28 rotates its output shaft in a first direction to cause the gears 32 and 34 of the geartrain 30 and the rotational screw 26 to rotate. Rotation of the rotational screw 26 translates the movable piston 24 away from the end of the clutch master cylinder 20 and the clutch slave cylinder 16 and causes the diaphragm spring 14 to move such that the clutch plates 12a engage the clutch discs 12b. When this occurs, the output of the engine is connected to the input shaft 12c and the input shaft 12c rotates. As illustrated in FIG. 3, the motor 28 rotates its output shaft in a second direction opposite the first direction to cause the gears 32 and 34 of the geartrain 30 and the rotational screw 26 to rotate. Rotation of the rotational screw 26 translates the movable piston 24 toward the end of the clutch master cylinder 20 to move fluid to the clutch slave cylinder 16, which causes the diaphragm spring 14 to move such that the clutch plates 12a disengage the clutch discs 12b. When this occurs, the output of the engine is disconnected to the input shaft 12c and the input shaft 12c does not rotate.

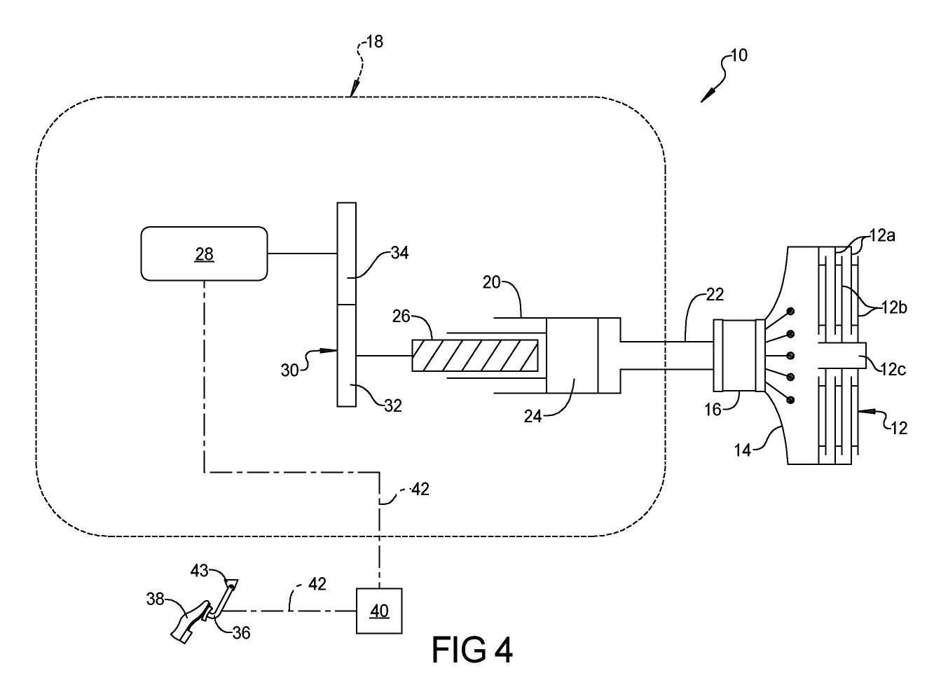

Referring to FIG. 4, the system 10 may actuate the clutch 12, in one embodiment, by a clutch by wire connection. In this embodiment, the system 10 includes a movable clutch footpedal 36 operated by a foot 38 of a vehicle operator (not shown) and a computer or electronic control module (ECM) 40 in communication with the clutch footpedal 36 and the motor 38 by a suitable mechanism such as one or more wires 42. The system 10 may include a clutch footpedal sensor 43 positioned near or coupled to the clutch footpedal 36 and in communication with the ECM 40 to sense a position of the clutch footpedal 36. It should be appreciated that, when the vehicle operator uses their foot 38 to move the clutch footpedal 36, the ECM 40 sends a corresponding signal to the motor 28 to cause the motor 28 to rotate its output shaft in either the first or second direction to actuate the clutch 12. It should also be appreciated that the clutch footpedal 36 and clutch footpedal sensor 43 are conventional and known in the art. It should further be appreciated that the ECM 40 may communicate with the clutch footpedal sensor 43 or other sensors s via a bus, hard wires, or a combination thereof. It should still further be appreciated that the ECM 40 is programmed to rotate the output of the motor 28 based on vehicle controls such as a signal from the clutch footpedal sensor 43 and one or more other sensors (not shown).

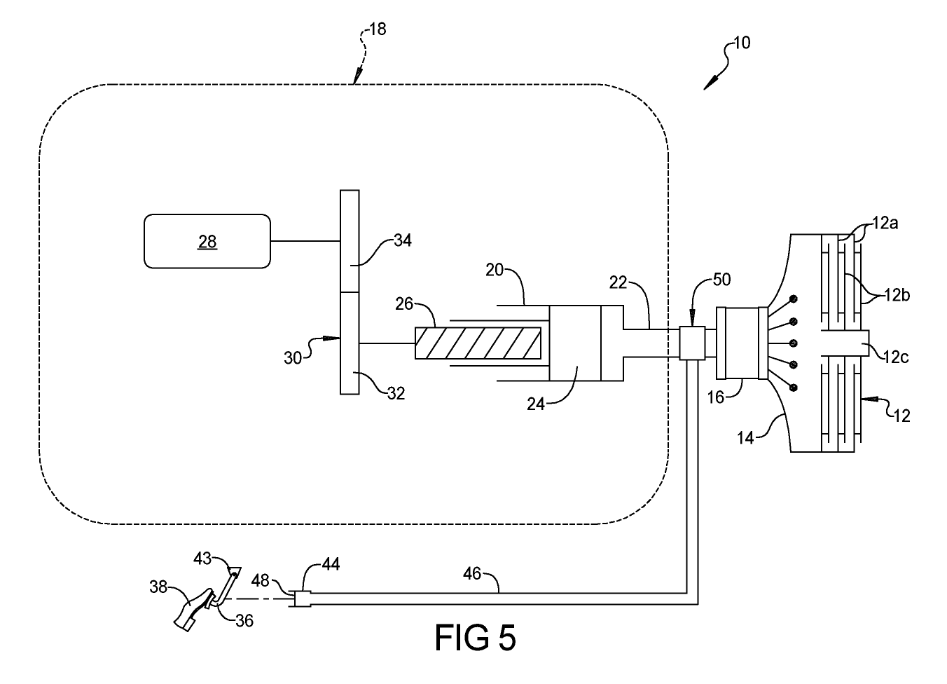

Referring to FIG. 5, the system 10 may actuate the clutch 12, in one embodiment, by a clutch by fluid connection. In this embodiment, the system 10 includes the movable footpedal 36 operated by the foot 38 of the vehicle operator or driver (not shown) and a footpedal master cylinder 44 fluidly connected by a conduit 46 to the clutch slave cylinder 16 having a movable piston 48 coupled to the clutch footpedal 36 and disposed in the footpedal master cylinder 44. It should be appreciated that, when the vehicle operator uses their foot 38 to move the clutch footpedal 36, the piston 48 causes movement of fluid to actuate the clutch slave cylinder 16.

Referring to FIG. 5, the system 10 may include a clutch manual override assembly, generally indicated at 50, to allow manual override of the electronic clutch actuator 18. In one embodiment, the clutch manual override assembly 50 includes a solenoid switch valve 52 fluidly connected to the fluid conduit 46 and to the clutch slave cylinder 16. The clutch manual override assembly 50 also includes a fluid accumulator 54 fluidly connected to the solenoid switch valve 52. It should be appreciated that the solenoid switch valve 52 is electrically connected to a source of power such as the ECM 40.

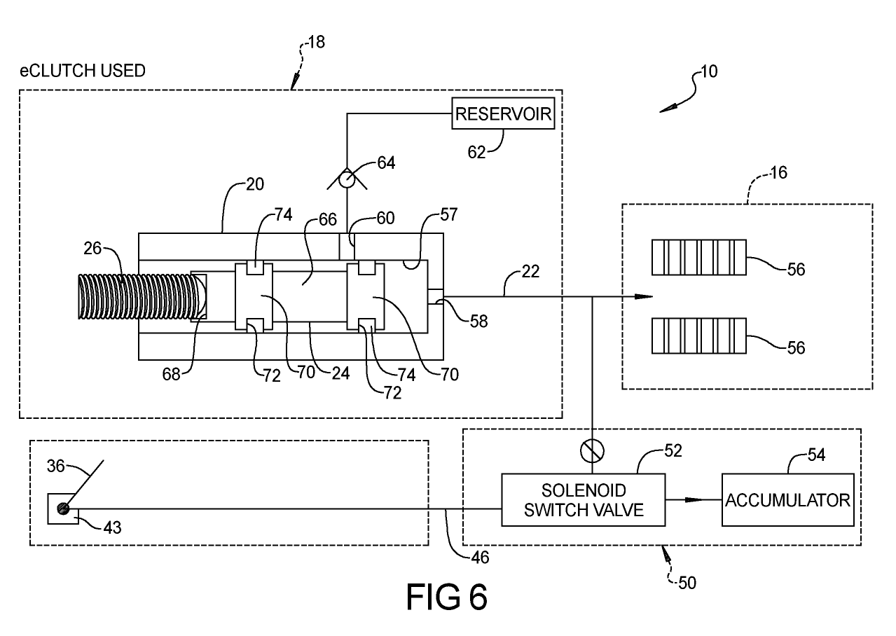

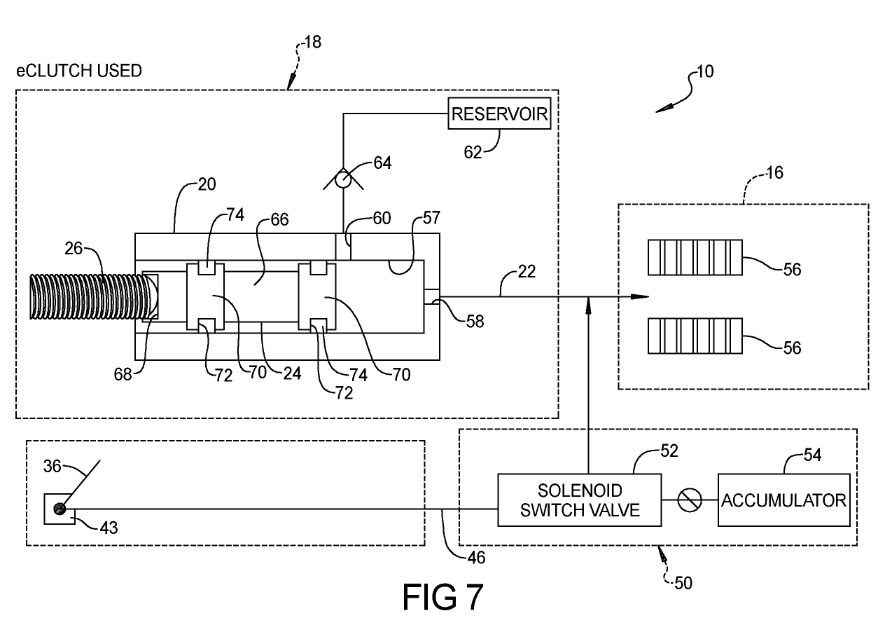

Referring to FIGS. 6 and 7, the system 10 is illustrated with the electronic clutch actuator 18 being used or not being used, respectively. As illustrated in FIG. 6, when the electronic clutch actuator 18 is being driven or used and the vehicle operator uses their foot 38 to move the clutch footpedal 36, the solenoid switch valve 52 allows fluid flow from the clutch footpedal 36 to the fluid accumulator 54. Thus, fluid flow is blocked to the clutch slave cylinder 16. It should be appreciated that the fluid accumulator 54 has the same feedback to the clutch footpedal 36 as the clutch slave cylinder 16 would have. It should also be appreciated that the electronic clutch actuator 18 is driven from vehicle controls via the ECM 40.

As illustrated in FIG. 7, when the electronic clutch actuator 18 is not being driven or used and the vehicle operator uses their foot 38 to move the clutch footpedal 36, the solenoid switch valve 52 allows fluid flow to the clutch slave cylinder 16. Thus, fluid flow is blocked to the fluid accumulator 54. It should be appreciated that, if the electronic clutch actuator 18 fails for any reason during use, this manual operation allows the clutch footpedal 36 to still operate as normal to manually actuate the clutch 12. It should further be appreciated that the electronic clutch actuator 18 is for automated manual clutch transmissions.

Referring again to FIGS. 6 and 7, the clutch slave cylinder 16 includes a movable piston 56 coupled to the diaphragm spring 14. In one embodiment, the clutch master cylinder 20 is generally cylindrical in shape and extends axially. The clutch master cylinder 20 has a cavity 57 extending axially therein. The cavity 57 has a generally circular cross-section. The clutch master cylinder 20 includes a first port 58 extending through one end for fluid communication between the cavity 57 and the clutch slave cylinder 16 to move the movable piston 24. The clutch master cylinder 20 also includes a second port 60 extending through a side thereof for fluid communication between the cavity 57 and a fluid reservoir 62. The electronic clutch actuator 18 may include a check valve 64 disposed in fluid communication between the second port 60 and the fluid reservoir 62 to allow one way fluid flow from the second port 60 to the fluid reservoir 62.

As illustrated in FIGS. 6 and 7, in one embodiment, the piston 24 is generally cylindrical in shape and extends axially. The piston 24 includes a shaft 66 extending axially. The shaft 66 is generally cylindrical in shape with a generally circular cross-section. The shaft 66 has a cavity 68 extending axially into one end thereof to receive an end of the rotatable screw 26. The piston 24 includes one or more lands 70 extending radially from and spaced axially along the shaft 66. In the embodiment illustrated, one land 70 is disposed axially at the end of the shaft 66 opposite the cavity 68 and another land 70 is disposed axially between the land 70 and the cavity 68. The lands 70 are generally cylindrical in shape with a generally circular cross-section. Each of the lands 70 have a groove 72 extending circumferentially therealong and radially therein. The piston 24 further includes a seal 74 disposed in the groove 72 of each of the lands 70. The seal 74 is annular and made of a flexible material to engage a wall of the clutch master cylinder 20 to prevent fluid flow past the land 70. It should be appreciated that the piston 24 allows fluid to be routed to either the clutch slave cylinder 16 or the fluid reservoir 62. It should also be appreciated that the piston 24 may be a fluid switch valve.

In addition, a method, according to the present invention, is disclosed shown for actuation of the clutch 12 using the system 10 of FIG. 1. The method includes the steps of providing the electronic clutch actuator 18 in fluid communication with the clutch slave cylinder 16 and providing the manual override assembly 50 in fluid communication between the clutch footpedal 36 of the vehicle and the clutch slave cylinder 16. The method also includes the steps of preventing, by the manual override assembly 50, fluid flow from the clutch footpedal 36 to the clutch slave cylinder 16 when the electronic clutch actuator 18 is being used to electronically actuate the clutch slave cylinder 16. The method further includes the steps of allowing, by the manual override assembly 50, fluid flow from the clutch footpedal 36 to the clutch slave cylinder 16 when the electronic clutch actuator 18 is not being used to manually actuate the clutch slave cylinder 16.

Accordingly, the system 10 of the present invention is provided as an enhanced clutch system for actuation of the clutch 12 having the electronic clutch actuator 18 with manual operation for a transmission of a vehicle. The system 10 of the present invention allows both a vehicle driver and the system 10 to control the clutch 12 seamlessly for shifting. The system 10 of the present invention is an “add-on” to the clutch 12 without any change in a vehicle driver's actions.

The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the invention may be practiced other than as specifically described.

What is claimed is:

1. A system for actuation of a clutch in a transmission of a vehicle, said system comprising:
an electronic clutch actuator adapted to be in fluid communication with a clutch slave cylinder coupled to the clutch of the transmission; and
a manual override assembly adapted to be in fluid communication between a clutch footpedal of the vehicle and the clutch slave cylinder, wherein said manual override assembly prevents fluid flow from the clutch footpedal to the clutch slave cylinder when the electronic clutch actuator is being used to electronically actuate the clutch slave cylinder and allows fluid flow from the clutch footpedal to the clutch slave cylinder when the electronic clutch actuator is not being used to manually actuate the clutch slave cylinder.

2. A system as set forth in claim 1 wherein said manual override assembly comprises a solenoid switch valve adapted to be in fluid communication with the clutch footpedal and the clutch slave cylinder.

3. A system as set forth in claim 2 wherein said manual override assembly further comprises a fluid accumulator fluidly communicating with said solenoid switch valve.

4. A system as set forth in claim 3 including an electronic control module in communication with said solenoid switch valve to actuate said solenoid switch valve to allow fluid flow to said fluid accumulator when said electronic clutch actuator is being used and to allow fluid flow to the clutch slave cylinder when said electronic clutch actuator is not being used.

5. A system as set forth in claim 4 including a clutch footpedal sensor communicating with said electronic control module and adapted to sense a position of the clutch footpedal.

6. A system as set forth in claim 4 wherein said electronic clutch actuator comprises a clutch master cylinder adapted to fluidly communicate with the clutch slave cylinder.

7. A system as set forth in claim 6 wherein said electronic clutch actuator further comprises a movable piston disposed inside said clutch master cylinder.

8. A system as set forth in claim 7 wherein said electronic clutch actuator further comprises a rotatable screw coupled to said movable piston to translate said movable piston.

9. A system as set forth in claim 8 wherein said electronic clutch actuator further comprises a motor coupled to said rotatable screw and in communication with said electronic control module to rotate said rotatable screw.

10. A system as set forth in claim 9 wherein said electronic clutch actuator further comprises a geartrain disposed between said motor and said rotatable screw to reduce a speed between an output of said motor and said rotatable screw.

11. A system as set forth in claim 10 wherein said geartrain comprises a first gear coupled to said rotatable screw and a second gear coupled to the output of said motor and meshingly engaging said first gear.

12. A system for actuation of a clutch in a transmission of a vehicle, said system comprising:
a clutch slave cylinder coupled to the clutch of the transmission;
a footpedal master cylinder adapted to be coupled to a movable clutch footpedal of the vehicle and in fluid communication with said clutch slave cylinder;
a clutch pedal sensor adapted to sense a position of the clutch footpedal;
an electronic control module in communication with said clutch footpedal sensor to receive a signal of the sensed position of the clutch footpedal;
an electronic clutch actuator in fluid communication with said clutch slave cylinder and in communication with said electronic control module to electronically actuate said clutch slave cylinder based on the signal; and
a manual override assembly in fluid communication between said footpedal master cylinder and said clutch slave cylinder to manually actuate said clutch slave cylinder, wherein said manual override assembly prevents fluid flow from said footpedal master cylinder to said clutch slave cylinder when said electronic clutch actuator is being used and allows fluid flow from said footpedal master cylinder to said clutch slave cylinder when said electronic clutch actuator is not being used.

13. A system as set forth in claim 12 wherein said manual override assembly comprises a solenoid switch valve adapted to be in fluid communication with said footpedal master cylinder and said clutch slave cylinder.

14. A system as set forth in claim 13 wherein said manual override assembly further comprises a fluid accumulator fluidly communicating with said solenoid switch valve.

15. A system as set forth in claim 12 wherein said electronic clutch actuator comprises a clutch master cylinder fluidly communicating with said clutch slave cylinder.

16. A system as set forth in claim 15 wherein said electronic clutch actuator further comprises a movable piston disposed inside said clutch master cylinder.

17. A system as set forth in claim 16 wherein said electronic clutch actuator further comprises a rotatable screw coupled to said movable piston to translate said movable piston.

18. A system as set forth in claim 17 wherein said electronic clutch actuator further comprises a motor coupled to said rotatable screw and in communication with said electronic control module to rotate said rotatable screw.

19. A system as set forth in claim 18 wherein said electronic clutch actuator further comprises a geartrain disposed between said motor and said rotatable screw to reduce a speed between an output of the motor and said rotatable screw.

20. A method for actuation of a clutch in a transmission of a vehicle, said method comprising the steps of:
providing an electronic clutch actuator in fluid communication with a clutch slave cylinder coupled to the clutch of the transmission;
providing a manual override assembly in fluid communication between a clutch footpedal of the vehicle and the clutch slave cylinder;
preventing, by the manual override assembly, fluid flow from the clutch footpedal to the clutch slave cylinder when the electronic clutch actuator is being used to electronically actuate the clutch slave cylinder; and
allowing, by the manual override assembly, fluid flow from the clutch footpedal to the clutch slave cylinder when the electronic clutch actuator is not being used to manually actuate the clutch slave cylinder.
